(19) United States
(12) Patent Application Publication
(10) Pub. No.: US 2017/0289973 A1
(43) Pub. Date: Oct. 5, 2017

(54) METHOD AND USER EQUIPMENT FOR RECEIVING DOWNLINK SIGNAL, AND METHOD AND BASE STATION FOR TRANSMITTING DOWNLINK SIGNAL

(71) Applicant: LG ELECTRONICS INC., Seoul (KR)

(72) Inventors: Suckchel YANG, Seoul (KR); Joonkui AHN, Seoul (KR); Yunjung YI, Seoul (KR)

(73) Assignee: LG ELECTRONICS INC., Seoul (KR)

(21) Appl. No.: 15/507,983

(22) PCT Filed: Sep. 23, 2015
(86) PCT No.: PCT/KR2015/010010

§ 371 Date: Mar. 1, 2017

Related U.S. Application Data
(60) Provisional application No. 62/054,375, filed on Sep. 23, 2014.

(51) Int. Cl. H04W 72/04; H04L 27/26

(52) U.S. Cl. CPC H04W 72/042; H04W 72/0453; H04L 27/26

(57) ABSTRACT

Provided are a user equipment configured to be operated within a particular predetermined band smaller than the entire system band and a base station supporting the user equipment. A reference signal and a downlink control channel on the basis of the reference signal are transmitted to the user equipment within the particular band in a subframe. The downlink control channel is transmitted within one or more orthogonal frequency division multiplexing (OFDM) symbols except a predetermined number of leading OFDM symbols among OFDM symbols in the subframe. The reference signal is transmitted in at least one of the one or more OFDM symbols.

### TECHNICAL FIELD

The present invention relates to a wireless communication system and, more particularly, to a method for receiving or transmitting downlink signal and an apparatus therefor.

### BACKGROUND ART

Wireless communication systems have been widely deployed to provide various types of communication services such as voice or data. In general, a wireless communication system is a multiple access system that supports communication with multiple users by sharing available system resources (bandwidth, transmission power, etc.). For example, multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. WiMAX may be described based on the IEEE an 802.16e standard (WirelessMAN-OFDMA reference system) and the evolved IEEE 802.16m standard (WirelessMAN-OFDMA advanced system).

Recently, in a communication technology standardization institute (e.g. 3GPP, IEEE, etc.) that establishes a next-generation communication technology standard (e.g. beyond LTE-A), a machine type communication (MTC) has emerged as one important standardization issue. MTC refers to information exchange between a machine and a base station, performed without human intervention.

### DETAILED DESCRIPTION OF THE INVENTION

### Technical Problems

A communications service provided through MTC is different from a legacy communication service involving human interaction and, therefore, it is necessary to define a new communication method suitable for MTC.

The technical objects that can be achieved through the present invention are not limited to what has been particularly described hereinabove and other technical objects not described herein will be more clearly understood by persons skilled in the art from the following detailed description.

### Technical Solutions

To solve the above technical problems, a user equipment (UE) configured to operate in a specific band that is preconfigured to be smaller than an entire system band and a base station that support the user equipment are provided.

In an aspect of the present invention, provided herein is a method of receiving a downlink signal by a user equipment (UE). The method may include receiving a reference signal and a downlink control channel based on the reference signal in a specific band preconfigured for the UE out of an entire system band of a subframe; and receiving a downlink data channel in the specific band of the subframe based on the downlink control channel. The specific band may be smaller than the entire system band. The downlink control channel may be received in one or more orthogonal frequency division multiplexing (OFDM) symbols except for a predetermined number of front OFDM symbols among OFDM symbols in the subframe. The downlink data channel may be received in remaining OFDM symbols, except the predetermined number of front symbols and the one or more OFDM symbols. The reference signal may be received in at least one of the one or more OFDM symbols.

In another aspect of the present invention, provided herein is a user equipment (UE) for receiving a downlink signal, including a receiver, and a processor configured to control the receiver. The processor may control the receiver to receive a reference signal and a downlink control channel based on the reference signal in a specific band preconfigured for the UE out of an entire system band of a subframe; and control the receiver to receive a downlink data channel in the specific band of the subframe based on the downlink control channel. The specific band may be smaller than the entire system band. The downlink control channel may be received in one or more orthogonal frequency division multiplexing (OFDM) symbols except for a predetermined number of front OFDM symbols among OFDM symbols in the subframe. The downlink data channel may be received in remaining OFDM symbols, except the predetermined number of front symbols and the one or more OFDM symbols. The reference signal may be received in at least one of the one or more OFDM symbols.

In another aspect of the present invention, provided herein is a method of transmitting a downlink signal by a base station (BS). The method may include transmitting a reference signal and a downlink control channel based on the reference signal in a specific band preconfigured for a user equipment (UE) out of an entire system band of a subframe to the UE; and transmitting a downlink data channel based on the downlink control channel to the UE in the specific band of the subframe. The specific band may be smaller than the entire system band. The downlink control channel may be transmitted in one or more orthogonal frequency division multiplexing (OFDM) symbols except for a predetermined number of front OFDM symbols among OFDM symbols in the subframe. The downlink data channel may be transmitted in remaining OFDM symbols, except the predetermined number of front symbols and the one or more OFDM symbols. The reference signal may be transmitted in at least one of the one or more OFDM symbols.

In another aspect of the present invention, provided herein is a base station (BS) for transmitting a downlink signal, including a transmitter, and a processor configured to control the transmitter. The processor may control the receiver to transmit a reference signal and a downlink control channel based on the reference signal in a specific band preconfigured for a user equipment (UE) out of an entire system band of a subframe to the UE; and control the receiver to transmit a downlink data channel based on the downlink control channel to the UE in the specific band of the subframe. The specific band may be smaller than the entire system band. The downlink control channel may be transmitted in one or more orthogonal frequency division multiplexing (OFDM) symbols except for a predetermined number of front OFDM symbols among OFDM symbols in the subframe. The downlink data channel may be transmitted in remaining OFDM symbols, except the predetermined number of front symbols and the one or more OFDM symbols. The reference signal may be transmitted in at least one of the one or more OFDM symbols.

In each aspect of the present invention, the reference signal may be at least a cell-specific reference signal defined for antenna port 0, a cell-specific reference signal defined for antenna port 1, or a cell-specific reference signal defined for antenna port 1, or a cell-specific reference signal defined for antenna port 3.

In each aspect of the present invention, if all of the one or more OFDM symbols on which the downlink control channel is received do not include a cell-specific reference signal, at least one of the one or more OFDM symbols may include an additional reference signal rather than the cell-specific reference signal.

In each aspect of the present invention, information indicating the one or more OFDM symbols on which the downlink control channel is transmitted/received may further be transmitted/received.

In each aspect of the present invention, information indicating a start OFDM symbol on which the downlink data channel is transmitted/received may further be transmitted/received.

The above technical solutions are merely some parts of the embodiments of the present invention and various embodiments into which the technical features of the present invention are incorporated can be derived and understood by persons skilled in the art from the following detailed description of the present invention.

### Advantageous Effect

According to the present invention, radio communication signals can be efficiently transmitted/received. Therefore, overall throughput of a wireless communication system is improved.

According to an embodiment of the present invention, a low-price/low-cost UE can communicate with a BS while maintaining compatibility with a legacy system.

According to an embodiment of the present invention, a UE can be implemented with low price/low cost.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates a radio frame structure for transmission of a synchronization signal (SS).

FIG. 4 illustrates the structure of a DL subframe used in a wireless communication system.

FIG. 5 illustrates a resource unit used to configure a DL control channel.

FIG. 6 illustrates the structure of a UL subframe used in a wireless communication system.

FIG. 7 illustrates exemplary transmission of a DL signal for MTC according to an embodiment of the present invention.

FIG. 8 illustrates exemplary transmission of a DL signal for MTC according to another embodiment of the present invention.

FIG. 9 is a block diagram illustrating elements of a transmitting device 10 and a receiving device 20 for implementing the present invention.

### MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AR The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port, a virtual antenna, or an antenna group. A node may be referred to as a point.

In the present invention, a cell refers to a prescribed geographic region to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between an eNB or node which provides a communication service to the specific cell and a UE. In a LTE/LTE-A based system, The UE may measure DL channel state received from a specific node using cell-specific reference signal(s) (CRS(s)) transmitted on a CRS resource allocated by antenna port(s) of the specific node to the specific node and/or channel state information reference signal(s) (CSI-RS(s)) transmitted on a CSI-RS resource. Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide a service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, coverage of the node may be associated with coverage of “cell” of a radio resource used by the node. Accordingly, the term “cell” may be used to indicate service coverage by the node sometimes, a radio resource at other times, or a range that a signal using a radio resource can reach with valid strength at other times.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS (UE-RS), a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signal.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCl/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

Hereinafter, OFDM symbol/subcarrier/RE to or for which CRS/DMRS/CSI-RS/SRS/UE-RS is assigned or configured will be referred to as CRS/DMRS/CSI-RS/SRS/UE-RS symbol/carrier/subcarrier/RE. For example, an OFDM symbol to or for which a tracking RS (TRS) is assigned or configured is referred to as a TRS symbol, a subcarrier to or for which the TRS is assigned or configured is referred to as a TRS subcarrier, and an RE to or for which the TRS is assigned or configured is referred to as a TRS RE. In addition, a subframe configured for transmission of the TRS is referred to as a TRS subframe. Moreover, a subframe in which a broadcast signal is transmitted is referred to as a broadcast subframe or a PBCH subframe and a subframe in which a synchronization signal (e.g. PSS and/or SSS) is transmitted is referred to a synchronization signal subframe or a PSS/SSS subframe. OFDM symbol/subcarrier/RE to or for which PSS/SSS is assigned or configured is referred to as PSS/SSS symbol/subcarrier/RE, respectively.

In the present invention, a CRS port, a UE-RS port, a CSI-RS port, and a TRS port refer to an antenna port configured to transmit a CRS, an antenna port configured to transmit a UE-RS, an antenna port configured to transmit a CSI-RS, and an antenna port configured to transmit a TRS, respectively. Antenna ports configured to transmit CRSs may be distinguished from each other by the locations of REs occupied by the CRSs according to CRS ports, antenna ports configured to transmit UE-RSs may be distinguished from each other by the locations of REs occupied by the UE-RSs according to UE-RS ports, and antenna ports configured to transmit CSI-RSs may be distinguished from each other by the locations of REs occupied by the CSI-RSs according to CSI-RS ports. Therefore, the term CRS/UE-RS/CSI-RS/TRS ports may also be used to indicate a pattern of REs occupied by CRSs/UE-RSs/CSI-RSs/TRSs in a predetermined resource region.

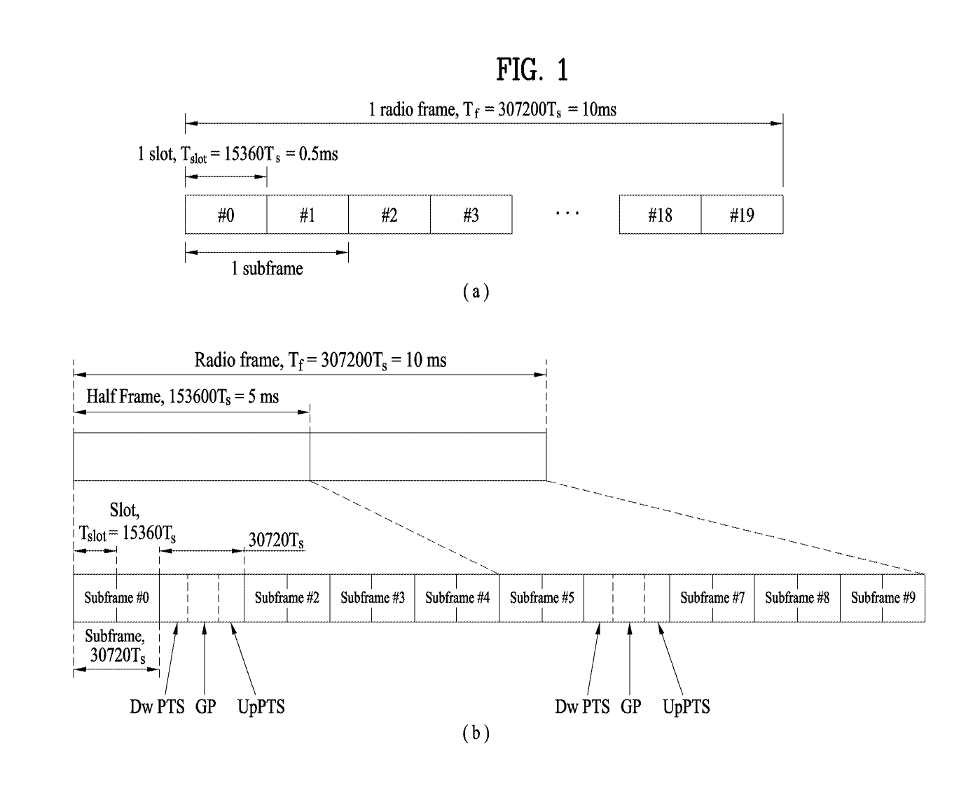

FIG. 1 illustrates the structure of a radio frame used in a wireless communication system.

Specifically, FIG. 1(a) illustrates an exemplary structure of a radio frame which can be used in frequency division multiplexing (FDD) in 3GPP LTE/LTE-A and FIG. 1(b) illustrates an exemplary structure of a radio frame which can be used in time division multiplexing (TDD) in 3GPP LTE/LTE-A. The frame structure of FIG. 1(a) is referred to as frame structure type 1 (FS1) and the frame structure of FIG. 1(b) is referred to as frame structure type 2 (FS2).

Referring to FIG. 1, a 3GPP LTE/LTE-A radio frame is 10 ms (307,200Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| | Downlink- | | | | | | | | | | |
|---|---|---|---|---|---|---|---|---|---|---|---|
| | to- | | | | | | | | | | |
| | Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | Normal cyclic prefix in | | | | | |
|---|---|---|---|---|---|---|
| | downlink | | | Extended cyclic prefix in | | |
| | | UpPTS | | downlink | | |
| | | Normal | | | UpPTS | |
| | | cyclic | Extended | | Normal | Extended |
| Special | | prefix | cyclic | | cyclic | cyclic |
| subframe | | in | prefix | | prefix in | prefix in |
| configuration | DwPTS | uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

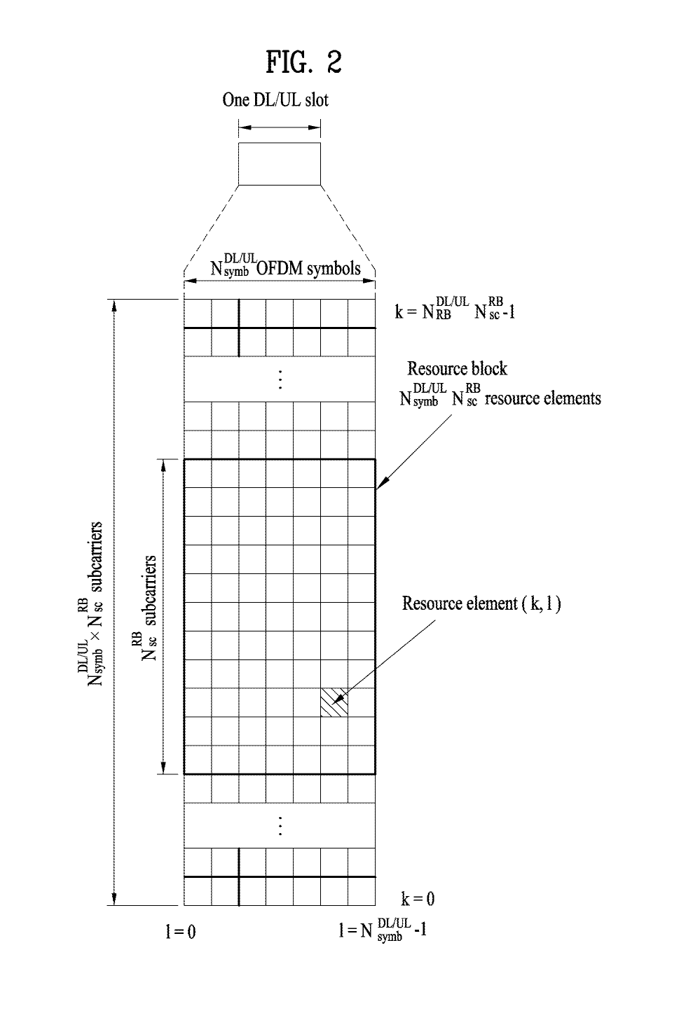

FIG. 2 illustrates the structure of a DL/UL slot structure in a wireless communication system. In particular, FIG. 2 illustrates the structure of a resource grid of a 3GPP LTE/LTE-A system. One resource grid is defined per antenna port.

Referring to FIG. 2, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}RB*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency ƒ₀ in a process of generating an OFDM signal or in a frequency up-conversion process. The carrier frequency is also called a center frequency ƒ_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}1−1 in the time domain.

Meanwhile, one RB is mapped to one physical resource block (PRB) and one virtual resource block (VRB). A PRB is defined as N^{DL}_{symb} (e.g. 7) consecutive OFDM or SC-FDM symbols in the time domain and N^{RB}_{sc} (e.g. 12) consecutive subcarriers in the frequency domain. Accordingly, one PRB is configured with N^{DL/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

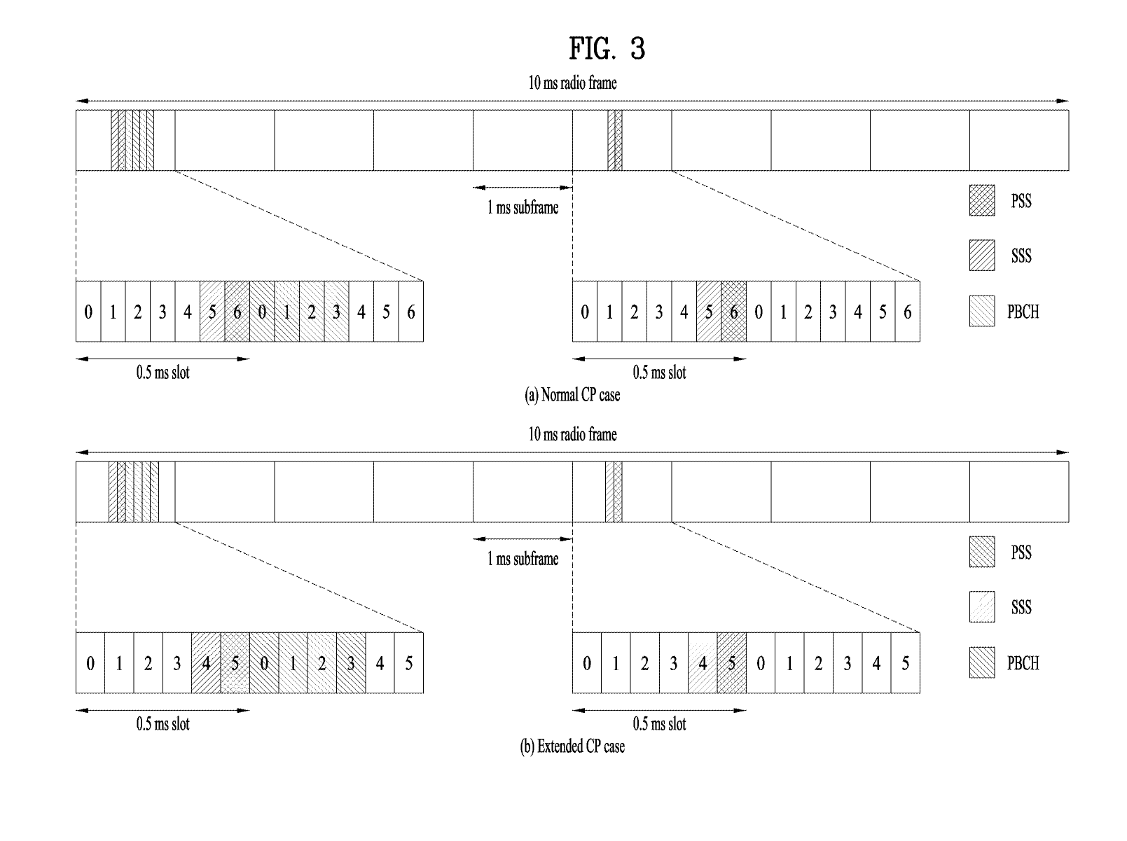

FIG. 3 illustrates a radio frame structure for transmission of a synchronization signal (SS). Specifically, FIG. 3 illustrates a radio frame structure for transmission of an SS and a PBCH in frequency division duplex (FDD), wherein FIG. 3(a) illustrates transmission locations of an SS and a PBCH in a radio frame configured as a normal cyclic prefix (CP) and FIG. 3(b) illustrates transmission locations of an SS and a PBCH in a radio frame configured as an extended CP.

If a UE is powered on or newly enters a cell, the UE performs an initial cell search procedure of acquiring time and frequency synchronization with the cell and detecting a physical cell identity N^{cell}_{ID} ) of the cell. To this end, the UE may establish synchronization with the eNB by receiving synchronization signals, e.g. a primary synchronization signal (PSS) and a secondary synchronization signal (SSS), from the eNB and obtain information such as a cell identity (ID).

An SS will be described in more detail with reference to FIG. 3. An SS is categorized into a PSS and an SSS. The PSS is used to acquire time-domain synchronization of OFDM symbol synchronization, slot synchronization, etc. and/or frequency-domain synchronization and the SSS is used to acquire frame synchronization, a cell group ID, and/or CP configuration of a cell (i.e. information as to whether a normal CP is used or an extended CP is used). Referring to FIG. 3, each of a PSS and an SSS is transmitted on two OFDM symbols of every radio frame. More specifically, SSs are transmitted in the first slot of subframe 0 and the first slot of subframe 5, in consideration of a global system for mobile communication (GSM) frame length of 4.6 ms for facilitation of inter-radio access technology (inter-RAT) measurement. Especially, a PSS is transmitted on the last OFDM symbol of the first slot of subframe 0 and on the last OFDM symbol of the first slot of subframe 5 and an SSS is transmitted on the second to last OFDM symbol of the first slot of subframe 0 and on the second to last OFDM symbol of the first slot of subframe 5. A boundary of a corresponding radio frame may be detected through the SSS. The PSS is transmitted on the last OFDM symbol of a corresponding slot and the SSS is transmitted on an OFDM symbol immediately before an OFDM symbol on which the PSS is transmitted. A transmit diversity scheme of an SS uses only a single antenna port and standards therefor are not separately defined.

Referring to FIG. 3, upon detecting a PSS, a UE may discern that a corresponding subframe is one of subframe 0 and subframe 5 because the PSS is transmitted every 5 ms but the UE cannot discern whether the subframe is subframe 0 or subframe 5. Accordingly, the UE cannot recognize the boundary of a radio frame only by the PSS. That is, frame synchronization cannot be acquired only by the PSS. The UE detects the boundary of a radio frame by detecting an SSS which is transmitted twice in one radio frame with different sequences.

A UE, which has demodulated a DL signal by performing a cell search procedure using an SSS and determined time and frequency parameters necessary for transmitting a UL signal at an accurate time, can communicate with an eNB only after acquiring system information necessary for system configuration of the UE from the eNB.

The system information is configured by a master information block (MIB) and system information blocks (SIBs). Each SIB includes a set of functionally associated parameters and is categorized into an MIB, SIB Type 1 (SIB1), SIB Type 2 (SIB2), and SIB3 to SIB8 according to included parameters. The MIB includes most frequency transmitted parameters which are essential for initial access of the UE to a network of the eNB. SIB1 includes parameters needed to determine if a specific cell is suitable for cell selection, as well as information about time-domain scheduling of the other SIBs.

The UE may receive the MIB through a broadcast channel (e.g. a PBCH). The MIB includes DL bandwidth (BW), PHICH configuration, and a system frame number SFN. Accordingly, the UE can be explicitly aware of information about the DL BW, SFN, and PHICH configuration by receiving the PBCH. Meanwhile, information which can be implicitly recognized by the UE through reception of the PBCH is the number of transmit antenna ports of the eNB. Information about the number of transmit antennas of the eNB is implicitly signaled by masking (e.g. XOR operation) a sequence corresponding to the number of transmit antennas to a 16-bit cyclic redundancy check (CRC) used for error detection of the PBCH.

The PBCH is mapped to four subframes during 40 ms. The time of 40 ms is blind-detected and explicit signaling about 40 ms is not separately present. In the time domain, the PBCH is transmitted on OFDM symbols 0 to 3 of slot 1 in subframe 0 (the second slot of subframe 0) of a radio frame.

In the frequency domain, a PSS/SSS and a PBCH are transmitted only in a total of 6 RBs, i.e. a total of 72 subcarriers, irrespective of actual system BW, wherein 3 RBs are in the left and the other 3 RBs are in the right centering on a DC subcarrier on corresponding OFDM symbols. Therefore, the UE is configured to detect or decode the SS and the PBCH irrespective of DL BW configured for the UE.

After initial cell search, a UE which has accessed a network of an eNB may acquire more detailed system information by receiving a PDCCH and a PDSCH according to information carried on the PDCCH. After performing the aforementioned procedure, the UE may perform PDDCH/PDSCH reception and PUSCH/PUCCH transmission as general uplink/downlink transmission procedures.

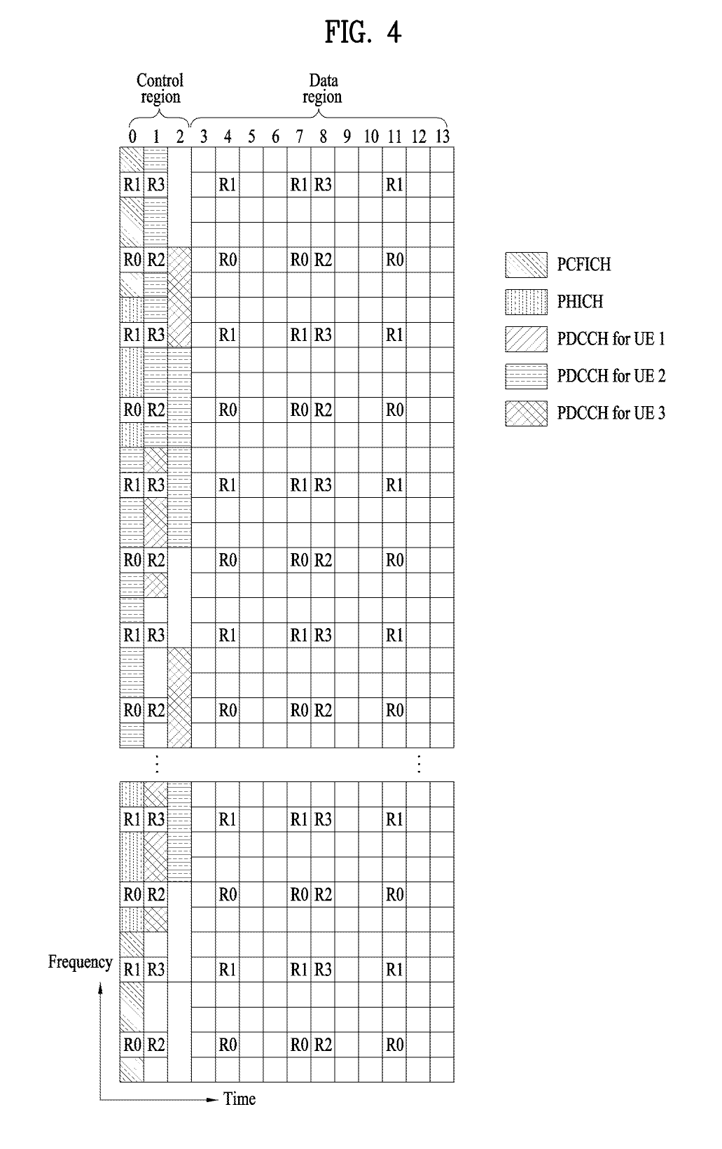

FIG. 4 illustrates the structure of a DL subframe used in a wireless communication system.

Referring to FIG. 4, a DL subframe is divided into a control region and a data region in the time domain. Referring to FIG. 4, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region.

Examples of a DL control channel used in 3GPP LTE include a physical control format indicator channel (PCFICH), a physical downlink control channel (PDCCH), a physical hybrid ARQ indicator channel (PHICH), etc.

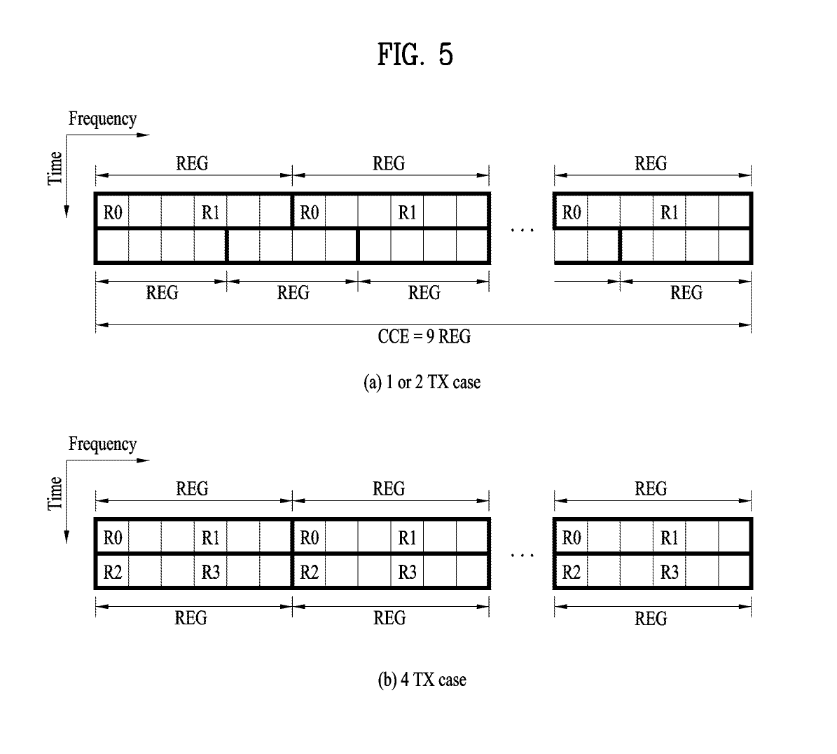

The PCFICH is transmitted in the first OFDM symbol of a subframe and carries information about the number of OFDM symbols available for transmission of a control channel within a subframe. The PCFICH notifies the UE of the number of OFDM symbols used for the corresponding subframe every subframe. The PCFICH is located at the first OFDM symbol. The PCFICH is configured by four resource element groups (REGs), each of which is distributed within a control region on the basis of cell ID. One REG includes four REs. One REG includes 4 REs. The structure of the REG will be described in more detail with reference to FIG. 5.

A set of OFDM symbols available for the PDCCH at a subframe is given by the following table.

TABLE 3

| | Number of | Number of |
|---|---|---|
| | OFDM | OFDM |
| | symbols for | symbols for |
| | PDCCH | PDCCH |
| | when | when |
| Subframe | N^{DL}_{RB} > 10 | N^{DL}_{RB} ≦ 10 |
| Subframe 1 and 6 for frame structure | 1, 2 | 2 |
| type 2 | | |
| MBSFN subframes on a carrier support- | 1, 2 | 2 |
| ing PDSCH, configured with 1 or 2 | | |
| cell-specific antenna ports | | |
| MBSFN subframes on a carrier support- | 2 | 2 |
| ing PDSCH, configured with 4 cell- | | |
| specific antenna ports | | |
| Subframes on a carrier not supporting | 0 | 0 |
| PDSCH | | |
| Non-MBSFN subframes (except sub- | 1, 2, 3 | 2, 3 |
| frame 6 for frame structure type 2) | | |
| configured with positioning | | |
| reference signals | | |
| All other cases | 1, 2, 3 | 2, 3, 4 |

The PCFICH carries a control format indicator (CFI), which indicates any one of values of 1 to 3. For a downlink system bandwidth N^{DL}_{RB}>10, the number 1, 2 or 3 of OFDM symbols which are spans of DCI carried by the PDCCH is given by the CFI. For a downlink system bandwidth N^{DL}_{RB}≦10, the number 2, 3 or 4 of OFDM symbols which are spans of DCI carried by the PDCCH is given by CFI+1. The CFI is coded in accordance with the following Table.

TABLE 4

| | CFI code word |
|---|---|
| CFI | <b₀, b₁, . . . , b₃₁> |
| 1 | <0, 1, 1, 0, 1, 1, 0, 1, 1, 0, 1, 1, 0, 1, 1, 0, |
| | 1, 1, 0, 1, 1, 0, 1, 1, 0, 1, 1, 0, 1, 1, 0, 1> |
| 2 | <1, 0, 1, 1, 0, 1, 1, 0, 1, 1, 0, 1, 1, 0, 1, 1, |
| | 0, 1, 1, 0, 1, 1, 0, 1, 1, 0, 1, 1, 0, 1, 1, 0> |
| 3 | <1, 1, 0, 1, 1, 0, 1, 1, 0, 1, 1, 0, 1, 1, 0, 1, |
| | 1, 0, 1, 1, 0, 1, 1, 0, 1, 1, 0, 1, 1, 0, 1, 1> |
| 4 | <0, 0, 0, 0, 0, 0, 0, 0, 0, 0, 0, 0, 0, 0, 0, 0, |
| (Reserved) | 0, 0, 0, 0, 0, 0, 0, 0, 0, 0, 0, 0, 0, 0, 0, 0> |

The PHICH carries a HARQ (Hybrid Automatic Repeat Request) ACK/NACK (acknowledgment/negative-acknowledgment) signal as a response to UL transmission. The PHICH includes three REGs, and is scrambled cell-specifically. ACK/NACK is indicated by 1 bit, and the ACK/NACK of 1 bit is repeated three times. Each of the repeated ACK/NACK bits is spread with a spreading factor (SF) 4 or 2 and then mapped into a control region.

For PUSCH transmissions in subframe n, a UE shall determine the corresponding PHICH resource in subframe n+k_{PHICH}, where k_{PHICH} is always 4 for FDD and is determined according to the following table for TDD.

TABLE 5

| TDD UL/DL | UL subframe index n | | | | | | | | | |
|---|---|---|---|---|---|---|---|---|---|---|
| configuration | 0 | 1 | 2 | 3 | 4 | 5 | 6 | 7 | 8 | 9 |

| | | | | | | |
|---|---|---|---|---|---|---|
| 0 | 4 | 7 | 6 | 4 | 7 | 6 |
| 1 | 4 | 6 | | 4 | 6 | |
| 2 | 6 | | | 6 | | |
| 3 | 6 | 6 | 6 | | | |
| 4 | 6 | 6 | | | | |
| 5 | 6 | | | | | |
| 6 | 4 | 6 | 6 | 4 | 7 | |

A plurality of PHICHs mapped to a set of the same REs forms a PHICH group and PHICHs in the same PHICH group are distinguished from each other through different orthogonal sequences. The PHICH resource is identified by the index pair (n^{group}_{PHICH}, n^{seq}_{PHICH}). n^{group}_{PHICH} the PHICH group number and n^{seq}_{PHICH} is the orthogonal sequence index within the group. n^{group}_{PHICH} and n^{seq}_{PHICH} can be determined according to the following equation, for example.

n_{PHICH}^{group}=(I_{PRB}_{_}_{RA}+n_{DMRS})mod N_{PHICH}^{group}+1_{PHICH}N_{PHICH}^{group}

n_{PHICH}^{seq}=(└I_{PRB}_{_{RA}}/N_{PHICH}^{group}┘+n_{DMRS})mod 2N_{SF}^{PHICH} Equation 1

Herein, N_{DMRS} is a value indicating a cyclic shift applied to a DMRS for a corresponding PUSCH. n_{DMRS} is obtained from a value set to the cyclic shift for DMRS field in the most recent DCI format 0. The DCI format 0 is used for scheduling of PUSCH. PDCCH with uplink DCI format [4] for the transport block(s) associated with the corresponding PUSCH transmission. n_{DMRS} may be mapped based on a value set in the field in DCI format 0, for example, according to the following table.

TABLE 6

| Cyclic Shift for DMRS | |
|---|---|
| Field in DCI format 0 | n_{DMRS} |
| 000 | 0 |
| 001 | 1 |
| 010 | 2 |
| 111 | 3 |
| 100 | 4 |
| 101 | 5 |
| 110 | 6 |
| 111 | 7 |

If a PDCCH having a UL DCI format for the same transport block is not present and an initial PUSCH for the same transport block is scheduled semi-persistently or by a random access response grant, n_{DMRS} is set to 0.

N^{PHICH}_{SF} is the spreading factor size used for PHICH modulation.

I_{PRB}_{_}_{RA}=I^{lowest}^{_}^{index}_{PRB}_{_}_{RA} [symbol] for the transport block (TB) of a PUSCH with associated PDCCH or for the case of no associated PDCCH when the number of negatively acknowledged TBs is not equal to the number of TBs indicated in the most recent PDCCH associated with the corresponding PUSCH, and I_{PRB}_{_{RA}}=I^{lowest}^{_}^{index} _{PRB}_{_{—RA}}+1 for a second TB of a PUSCH with associated PDCCH, where I^{lowest}^{_}^{index}_{PRB}_{_}_{RA} is the lowest PRB index in the first slot of the corresponding PUSCH transmission. I_{PHICH} is a value set to 1 or 0. I_{PHICH}=1 for TDD UL/DL configuration 0 with PUSCH transmission in subframe n=4 or 9, and I_{PHICH}=0 otherwise. N^{group}_{PHICH} represents the number of PHICH groups configured by a higher layer. The number of PHICH groups, N^{group}_{PHICH}, may be determined as follows.

$${N}_{PHICH}^{group} = \{ \begin{matrix}⌈ {N}_{8} ( {N}_{RB}^{DL} \text{/} 8 ) ⌉ & for normal cyclic prefix \\ 2 \cdot ⌈ {N}_{g} ( {N}_{RB}^{DL} \text{/} 8 ) ⌉ & for extended cyclic prefix\end{matrix} \qquad Equation 2$$

Herein, N_{g} is a value that is selected from among four values of {⅙, ½, 1, 2} and signaled by a higher layer. For example, when a system band is 25 RBs and a normal CP is used, N^{group}_{PHICH} is {1, 2, 4, 7} with respect to N_{g} of {⅙, ½, 1, 2}. The PHICH group index n^{group}_{PHICH} has a range from 0 to N^{group}_{PHICH}−1.

In frame structure type 2, the number of PHICH groups varies between subframes and is given as mᵢ·N^{group}_{PHICH. N}^{group}_{PHICH} is given by Equation 2 and mᵢ is given by the following table with a UL-DL configuration provided by a higher-layer parameter called subframe assignment (subframeAssignment).

TABLE 7

| Uplink-downlink | Subframe number i | | | | | | | | | |
|---|---|---|---|---|---|---|---|---|---|---|
| configuration | 0 | 1 | 2 | 3 | 4 | 5 | 6 | 7 | 8 | 9 |
| 0 | 2 | 1 | 0 | 0 | 0 | 2 | 1 | 0 | 0 | 0 |
| 1 | 0 | 1 | 0 | 0 | 1 | 0 | 1 | 0 | 0 | 1 |
| 2 | 0 | 0 | 0 | 1 | 0 | 0 | 0 | 0 | 1 | 0 |
| 3 | 1 | 0 | 0 | 0 | 0 | 0 | 0 | 0 | 1 | 1 |
| 4 | 0 | 0 | 0 | 0 | 0 | 0 | 0 | 0 | 1 | 1 |
| 5 | 0 | 0 | 0 | 0 | 0 | 0 | 0 | 0 | 1 | 0 |
| 6 | 1 | 1 | 0 | 0 | 0 | 1 | 1 | 0 | 0 | 1 |

In a subframe with non-zero PHICH resources, the PHICH group index n^{group}_{PHICH} has a range from 0 to mᵢ·N^{group}_{PHICH}−1.

The control information transmitted through the PDCCH will be referred to as downlink control information (DCI). The DCI includes resource allocation information for a UE or UE group and other control information. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 2C, 3 and 3A are defined for a DL. Combination selected from control information such as a hopping flag, RB allocation, modulation coding scheme (MCS), redundancy version (RV), new data indicator (NDI), transmit power control (TPC), cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, a radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at the bit level.

A PDCCH is allocated to the first m OFDM symbol(s) in a subframe wherein m is an integer equal to or greater than 1 and is indicated by a PCFICH.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, one CCE corresponds to nine resource element groups (REGs), and one REG corresponds to four REs. Four QPSK symbols are mapped to each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH).

Assuming that the number of REGs not allocated to the PCFICH or the PHICH is N_{REG}, the number of available CCEs in a DL subframe for PDCCH(s) in a system is numbered from 0 to N_{CCE}−1 where N_{CCE}=floor(N_{REG}/9).

A DCI format and the number of DCI bits are determined in accordance with the number of CCEs. The CCEs are numbered and consecutively used. To simplify the decoding process, a PDCCH having a format including n CCEs may be initiated only on CCEs assigned numbers corresponding to multiples of n. The number of CCEs used for transmission of a specific PDCCH is determined by a network or the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

The following table illustrates PDCCH formats.

TABLE 8

| PDCCH | Number of | Number of | Number of |
|---|---|---|---|
| format | CCEs | REGs | PDCCH bits |
| 0 | 1 | 9 | 72 |
| 1 | 2 | 18 | 144 |
| 2 | 4 | 36 | 288 |
| 3 | 8 | 72 | 576 |

An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) “A” and information about data transmitted using a radio resource “B” (e.g. frequency location) and using transport format information “C” (e.g. transmission block size, modulation scheme, coding information, etc.) is transmitted in a specific DL subframe. Then, the UE monitors the PDCCH using RNTI information thereof. The UE having the RNTI “A” receives the PDCCH and receives the PDSCH indicated by “B” and “C” through information of the received PDCCH.

If RRH technology, cross-carrier scheduling technology, etc. are introduced, the amount of PDCCH which should be transmitted by the eNB is gradually increased. However, since a size of a control region within which the PDCCH may be transmitted is the same as before, PDCCH transmission acts as a bottleneck of system throughput. Although channel quality may be improved by the introduction of the aforementioned multi-node system, application of various communication schemes, etc., the introduction of a new control channel is required to apply the legacy communication scheme and the carrier aggregation technology to a multi-node environment. Due to the need, a configuration of a new control channel in a data region (hereinafter, referred to as PDSCH region) not the legacy control region (hereinafter, referred to as PDCCH region) has been discussed. Hereinafter, the new control channel will be referred to as an enhanced PDCCH (hereinafter, referred to as EPDCCH). The EPDCCH may be configured within rear OFDM symbols starting from a configured OFDM symbol, instead of front OFDM symbols of a subframe. The EPDCCH may be configured using continuous frequency resources, or may be configured using discontinuous frequency resources for frequency diversity. By using the EPDCCH, control information per node may be transmitted to a UE, and a problem that a legacy PDCCH region may not be sufficient may be solved. For reference, the PDCCH may be transmitted through the same antenna port(s) as that (those) configured for transmission of a CRS, and a UE configured to decode the PDCCH may demodulate or decode the PDCCH by using the CRS. Unlike the PDCCH transmitted based on the CRS, the EPDCCH is transmitted based on the demodulation RS (hereinafter, DMRS). Accordingly, the UE decodes/demodulates the PDCCH based on the CRS and decodes/demodulates the EPDCCH based on the DMRS. The DMRS associated with EPDCCH is transmitted on the same antenna port p∈{107, 108, 109, 110} as the associated EPDCCH physical resource, is present for EPDCCH demodulation only if the EPDCCH transmission is associated with the corresponding antenna port, and is transmitted only on the PRB(s) upon which the corresponding EPDCCH is mapped. For example, the REs occupied by the UE-RS(s) of the antenna port 7 or 8 may be occupied by the DMRS(s) of the antenna port 107 or 108 on the PRB to which the EPDCCH is mapped, and the REs occupied by the UE-RS(s) of antenna port 9 or 10 may be occupied by the DMRS(s) of the antenna port 109 or 110 on the PRB to which the EPDCCH is mapped. In other words, a certain number of REs are used on each RB pair for transmission of the DMRS for demodulation of the EPDCCH regardless of the UE or cell if the type of EPDCCH and the number of layers are the same as in the case of the UE-RS for demodulation of the PDSCH.

An EPDCCH is transmitted using an aggregation of one or several consecutive enhanced control channel elements (ECCEs). Each ECCE consists of multiple enhanced resource element groups (EREGs). EREGs are used for defining the mapping of enhanced control channels to resource elements. There are 16 EREGs, numbered from 0 to 15, per physical resource block (PRB) pair. Number all resource elements (REs), except resource elements carrying DMRS (hereinafter, EPDCCH DMRS) for demodulation of the EPDCCH, in a physical resource-block pair cyclically from 0 to 15 in an increasing order of first frequency. Therefore, all the REs, except REs carrying the EPDCCH DMRS, in the PRB pair has any one of numbers 0 to 15. All REs with number i in that PRB pair constitutes EREG number i. As described above, it is noted that EREGs are distributed on frequency and time axes within the PRB pair and an EPDCCH transmitted using aggregation of one or more ECCEs, each of which includes a plurality of EREGs, is also distributed on frequency and time axes within the PRB pair.

Referring back to FIG. 4, R0 to R3 denote CRSs for antenna ports 0 to 3. According to the number of antenna ports of a transmission node, CRS(s) of R0, R0 and R1, or R0 to R3 are transmitted. A CRS is fixed to a predetermined pattern in a subframe regardless of a control region and a data region. A control channel is allocated to a resource to which the CRS is not allocated in a control region and a data channel is allocated to a resource to which the CRS is not allocated in a data region.

In a legacy 3GPP LTE system, since the CRS is used for both demodulation and measurement, the CRS is transmitted throughout an entire DL bandwidth in all DL subframes in a cell supporting PDSCH transmission and is transmitted through all antenna ports configured for an eNB.

Specifically, a CRS sequence rᵢ,(m) is defined according to the following equation.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = 0 , 1 , … , 2 {N}_{RB}^{max , DL} - 1 \qquad Equation 3$$

Herein, nₛ is a slot number in a radio frame and l is an OFDM symbol number in a slot.

In this case, N^{max,DL}_{RB} denotes the largest DL bandwidth configuration and is represented as an integer multiple of N^{RB}_{sc}. The pseudo-random sequence c(i) is defined by a length-31 Gold sequence. The output sequence c(n) of length M_{PN}, where n =0, 1, . . . , M_{PN}−1, is defined by the following equation.

c(n)=(x₁(n+N_{C})+x₂(n+N_{c}))mod 2

x₁(n+31)=(x₁(n+3)+x₁(n))mod 2

x₂(n+31)=(x₂(n+3)+x₂(n+2)+x₂(n+1)+x₂(n))mod 2 Equation 4

where N_{C}=1600 and the first m-sequence is initialized with x₁(0)=1, x₁(n)=0, n=1, 2, . . . , 30. The initialization of the second m-sequence is denoted by the following equation with the value depending on the application of the sequence.

cᵢₙᵢₜ=Σᵢ₊₀³⁰x₂(i)·2ⁱ Equation 5

In Equation 3, the pseudo-random sequence generator for generating c(i) is initialized with cᵢₙᵢₜ at the start of each subframe according to the following equation.

cᵢₙᵢₜ=2¹⁰·(7·(n_{S}+1)+l+1)·(2·N_{ID}^{cell}+1)+2·N_{ID}^{cell}+N_{CP} Equation 6

Herein, N^{cell}_{ID} denotes a physical cell ID (or a physical layer cell ID) that a UE can obtain based on a PSS/SSS and N_{CP} is a value defined as 1 for a normal CP and as 0 for an extended CP.

A CRS sequence r_{l,ns}(m) is mapped, according to the following equation, to complex-valued modulation symbols a^{(p)}_{k,l} used as reference symbols for an antenna port p in a slot nₛ.

a_{k,l}^{(p)}=r_{l,n}_{ₛ}(m') Equation 7

Herein, nₛ is a slot number in a radio frame and 1 is an OFDM symbol number in a slot and is determined according to the following equation.

$$k = 6 m + ( v + {v}_{shiftt} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \qquad Equation 8$$

Herein, N^{max,DL}_{RB} is the largest DL bandwidth configuration and is expressed as an integer multiple of N^{RB}_{sc}. N^{DL}_{RB} is a DL bandwidth configuration and is represented as an integer multiple of N_{RB}^{sc}. A UE is aware of the DL system bandwidth N^{DL}_{RB} from an MIB carried by a PBCH.

In Equation 8, DL parameters v and v_{shift} define locations in a frequency for other RSs and v is given by the following equation.

$$v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix} \qquad Equation 9$$

A cell-specific frequency shift v_{shift} is given by the following equation according to a physical layer cell ID N^{cell}_{ID}.

v_{shift}=N_{US}^{cell}mod 6 Equation 10

REs (k,l) used for transmission of CRSs over any one of antenna ports in a slot are not used for transmission of CRSs over any other antenna ports in the same slot and are set to 0. That is, powers of REs used for transmission of CRSs of other antenna ports in the same slot are set to 0 in corresponding antenna ports.

A UE may measure CSI using a CRS and demodulate, using the CRS, signals received through a PDCCH and/or a PDSCH in a subframe with the CRS. That is, an eNB transmits a CRS at a predetermined location in each RB in all RBs and the UE detects the PDCCH and/or the PDSCH after performing channel estimation based on the CRS. For example, the UE may measure a signal received on a CRS RE and detect a PDCCH/PDSCH signal from an RE to which the PDCCH/PDSCH is mapped using the measured signal and using a ratio of reception energy of each RE to which the PDCCH/PDSCH is mapped to reception energy of each CRS RE.

FIG. 5 illustrates a resource unit used to configure a DL control channel.

FIG. 5(a) illustrates a resource unit when the number of transmission antenna ports is 1 or 2 and FIG. 5(b) illustrates a resource unit when the number of transmission antenna ports is 4. Only CRS patterns are different according to the number of transmission antennas and methods of configuring a resource unit related to a control channel are identical. Referring to FIG. 5, a resource unit for a control channel is an REG. The REG includes 4 neighboring REs excluding a CRS. That is, the REG includes REs except for REs indicated by any one of R0 to R3 in FIG. 5. A PFICH and a PHICH include 4 REGs and 3 REGs. A PDCCH is configured in units of CCEs each including 9 REGs. While REGs constituting a CCE are adjacent to each other in FIG. 5, 9 REGs constituting the CCE may be distributed on a frequency and/or time axis in a control region.

A processing procedure of a PDCCH will now be described in more detail as follows.

The block of bits b(ⁱ)(0), . . . , b(ⁱ)(M(¹)_{bit}−1) on each of the control channels to be transmitted in a subframe, where M(')_{bit} is the number of bits in one subframe to be transmitted on physical downlink control channel number i, is multiplexed, resulting in a block of bits b⁽⁰⁾(0), . . . , b⁽⁰⁾(M⁽⁰⁾_{bit}−1), b⁽¹⁾(0), . . . , b⁽¹⁾(M⁽¹⁾_{bit}−1), . . . , b^{nPDCCH-1)}(0), . . . , b^{(nPDCCH-1)}(M^{(nPDCCH- 1)}_{bit}−1), where nPDCCH is the number of PDCCHs transmitted in the subframe. The block of bits b⁽¹⁾(0), . . . , b⁽¹⁾(M⁽¹⁾_{bit}−1), . . . , b^{(nPDCCH-1)}(0), . . . , b^{(nPDCCH-1)}_{bit}−1 [symbol] shall be scrambled with a cell-specific sequence prior to modulation, resulting in a block of scrambled bits \tilde{b}(0), . . . , \tilde{b}(Mₜₒₜ−1) according to the following equation.

\tilde{b}(i)=(b(i)+c(i))mod 2 Equation 11

where the scrambling sequence c(i) is given by Equation 4. The scrambling sequence generator is initialised by the following equation at the start of each subframe.

cᵢₙᵢₜ=└nₛ/2┘2⁹+N_{ID}^{cell} Equation 12

CCE number n corresponds to bits b(72n), b(72n+1), . . . , b(72n+71).

The block of scrambled bits \tilde{b}(0), . . . , \tilde{b}(Mₜₒₜ−1) is modulated by QPSK, resulting in a block of complex-valued modulation symbols d(0), . . . , d(M_{sym}−1).

The block of modulation symbols d(0), . . . , d(M_{symb}−1) is mapped to layers according to one of layer mapping for transmission on a single antenna port or layer mapping for transmit diversity and precoded according to one of precoding for transmission on a single antenna port or precoding for transmit diversity, resulting in a block of vectors y(i)=[v⁽⁰⁾(i) . . . y^{(P-1)}(i)] (where i=0, . . . , M_{symb}−1) to be mapped onto resources on the antenna ports used for transmission, where y^{(p)}(i) represents the signal for antenna port p.

The mapping to REs is defined by operations on quadruplets of complex-valued symbols. Let z^{(p)}(i)=<y^{(p)}(4i), y^{(p)}(4i+2), y^{(p)}(4i+3)> denote symbol quadruplet i for antenna port p. The block of quadruplets z^{(p)}(0), . . . , z^{(p)}(M_{quad}−1) (where M_{quad}=M_{symb}/4) is permuted resulting in w(^{p})(0), . . . , w^{(p)}M_{quad}−1).

The block of quadruplets w^{(p)}(0), . . . , w^{(p)}(M_{quad}−1)is cyclically shifted, resulting in w̅^{(p)}(0), . . . , w̅^{(p)}(M_{quad}−1) where w̅^{(p)}(i) =w^{(p)}((i+N_{ID}^{cell})mod M_{quad}).

Mapping of the block of quadruplets w̅^{(p)}(0), . . . , w̅^{(p)}(M_{quad}−1) is defined in terms of resource-element groups according to steps 1-10 below.

Step 1) Initialize m′=0 (REG number).

Step 2) Initialize k′=0.

Step 3) Initialize l′=0.

Step 4) If the resource element (k′,l′) represents a REG and the REG is not assigned to PCFICH or PHICH, then perform step 5 and step 6, else go to step 7.

Step 5) Map symbol-quadruplet w̅^{(p)}(m′) to the REG represented by (k′,l′) for each antenna port p.

Step 6) Increase m′ by 1.

Step 7) Increase l′ by 1.

Step 8) Repeat from step 4 if l′<L, where L corresponds to the number of OFDM symbols used for PDCCH transmission as indicated by the sequence transmitted on the PCFICH.

Step 9) Increase k′ by 1.

Step 10) Repeat from step 3 if k′<N^{DL}_{RB}·N^{RB}_{sc}.

Additionally, for more details of layer mapping, precoding, or permutation of the PDCCH, refer to documents of 3GPP LTE TS 36.211 and 3GPP LTE TS 36.212.

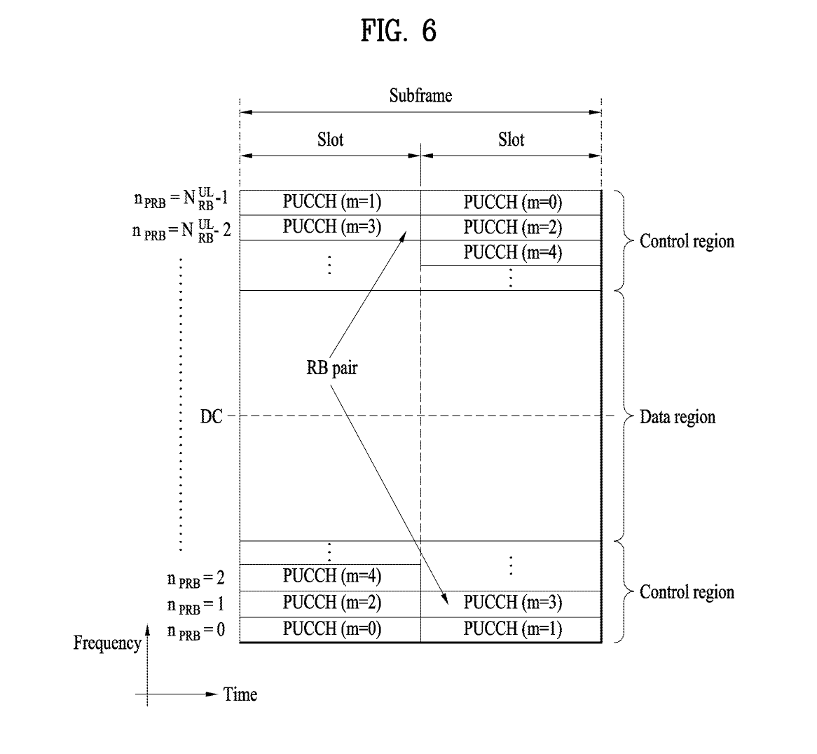

FIG. 6 illustrates the structure of a UL subframe used in a wireless communication system.

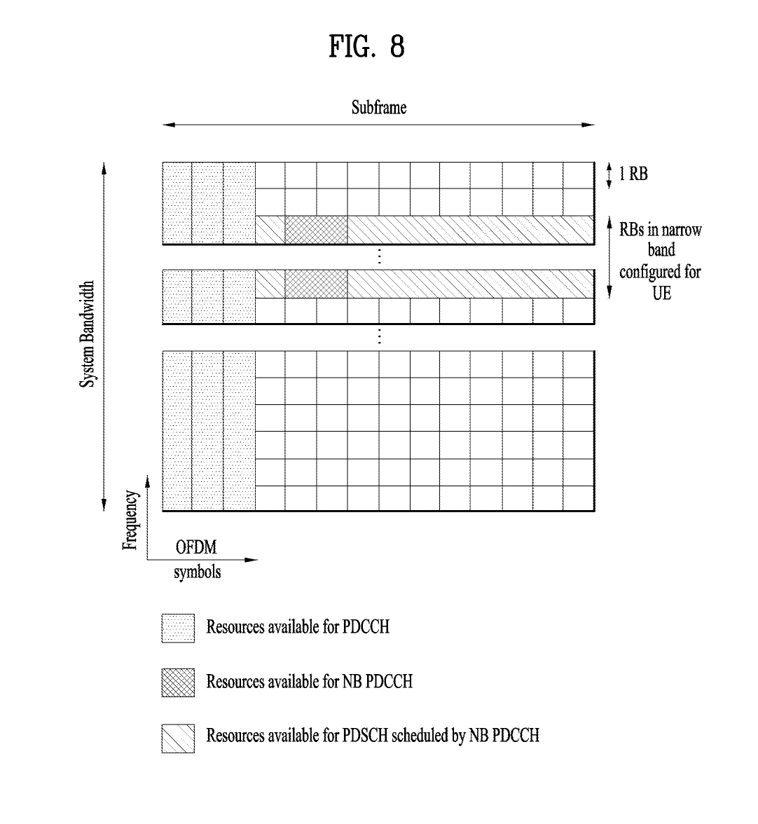

Referring to FIG. 8, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. CSI may include channel quality information (CQI), a precoding matrix indicator (PMI), a precoding type indicator, and/or a rank indicator (RI). In the CSI, multiple input multiple output (MIMO)-related feedback information includes the RI and the PMI. The RI indicates the number of streams or the number of layers that the UE can receive through the same time-frequency resource. The PMI is a value reflecting a space characteristic of a channel, indicating an index of a precoding matrix preferred by a UE for DL signal transmission based on a metric such as an SINR. The CQI is a value of channel strength, indicating a received SINR that can be obtained by the UE generally when an eNB uses the PMI.

In a next-generation system beyond 3GPP LTE(-A) (beyond LTE-(A) system), a low-cost/low-specification UE based on data communication such as meter reading, water level measurement, use of a surveillance camera, and inventory reporting of a vending machine is considered. Hereinafter, such a UE is referred to as an MTC device or an MTC UE. Since less data is transmitted by the MTC UE and many MTC UEs operate in one cell, if signal transmission for UL/DL scheduling/feedback is performed for each MTC UE at every moment, eNB overhead remarkably increases. In particular, if transmissions of UL data/feedback performed by the MTC UE are intermittent and not persistent, an eNB cannot persistently maintain UL time/frequency synchronization of the MTC UE. Therefore, for power saving of the MTC UE, it is desirable to perform UL data/feedback transmission by the MTC UE according to a random access preamble based RACH procedure.

Meanwhile, a situation in which a plurality of MTC UEs that perform the same/similar functions in a coverage-limited space such as a specific building or warehouse are deployed/operated may be considered. Hereinafter, a plurality of MTC UEs that perform the same/similar functions in a coverage-limited space will be referred to as an MTC group. The MTC group may be implemented to intermittently transmit low volumes of data. Particularly, in the case of UL synchronization, since the MTC UEs are adjacent to each other in a coverage-limited space, there is a high probability that UEs that belong to the same MTC group have similar time/frequency synchronization.

Since an MTC UE is used to transmit less data and perform occasionally generated UL/DL data transmission/reception, it is efficient to lower the cost of the UE and reduce battery consumption according to the low data transmission rate. In addition, the MTC UE has low mobility and, therefore, a channel environment thereof rarely changes. Meanwhile, in consideration of up to a poor situation in which the MTC UE is installed in a coverage-limited place such as a basement as well as a building or a factory, various coverage enhancement schemes including a repetitive transmission method for the MTC UE with respect to each channel/signal have been discussed.

As technology for a low-cost/low-specification UE, decrease in the number of reception antennas, decrease in a maximum transport block (TB) size, reduction in the operating frequency bandwidth (BW) of the UE, and the like, may be considered. In particular, reduction of the operating BW of the UE may be implemented such that the MTC UE can perform a signal transmission/reception operation only with respect to a predetermined BW (e.g. 1.4 MHz or 6 RBs) narrower than an actual system BW (e.g. 20 MHz or 100 RBs) in terms of radio frequency (RF) and/or baseband (BB) signal processing. If a minimum of 6 RBs is used for the system BW of the MTC UE, the MTC UE can advantageously discover/detect a cell that the MTC UE is to access by receiving and/or detecting a legacy PSS/SSS/PBCH. Meanwhile, in a legacy system, in the case of various DL control channels (e.g. a PCFICH and a PHICH) including a PDCCH, REs/REGs/CCEs constituting the control channels are transmitted over/throughout an entire system BW through a series of procedures such as interleaving and cyclic shift as illustrated in FIG. 4. When the UE needs to receive the control channel based on an entire system band of a connected RF, it is difficult to implement the UE with low-cost/low-specification. Therefore, for the MTC UE, a narrowband DL control channel (hereinafter, NB control channel) structure in which a signal is configured/transmitted only through a specific partial BW (narrower than a system BW) in an entire system BW needs to be considered. In addition, in consideration of frequency division multiplexing (FDM) between a plurality of MTC UEs and between an MTC UE and a legacy UE, a method of configuring a plurality of narrow BWs in the entire system BW and transmitting the NB control channel and a data channel (e.g. PDCCH) associated with the NB control channel through respective narrow BWs may be considered.

The present invention proposes a method of configuring and transmitting an NB control channel (e.g. a PDCCH, a PHICH, and/or a PCFICH) for support and scheduling of a narrowband MTC UE that operates in a BW narrower than a system BW. Hereinafter, a legacy wideband DL channel transmitted over/throughout the entire system BW will be referred to as a WB control channel for convenience.

Hereinafter, the present invention will be described on the premise that a narrow band (hereinafter, NB) is preconfigured for the UE. In other words, the present invention is based on the premise that the UE is aware of an NB configured therefor. Once the NB is configured for the UE, the NB is not fixed and is changeable.

For convenience of description, a PDCCH that is detected and/or received in an NB, i.e. only in a preconfigured NB, is referred to as an NB PDCCH and a PDCCH that is distributed over the entire legacy system band is referred to a WB PDCCH.

(1) Configuration of NB PDCCH transmission symbol for narrowband MTC

An NB PDCCH may be transmitted through one or more specific symbols located after a legacy WB PDCCH transmission symbol duration for a legacy UE. Herein, the legacy WB PDCCH transmission symbol duration (which is not changed over time in terms of an MTC UE):

1) may be fixed to a duration corresponding to a maximum number of WB PDCCH transmission symbols, or

2) may be directly (semi-statically) signaled/configured by an eNB.

For an NB PDCCH that is to be transmitted in an NB configured for a UE, the eNB may apply REG and CCE configuration, interleaving, cyclic shift, and RE mapping procedures under the assumption that the NB (e.g. 1.4 MHz or 6 RBs) is an entire system BW. The UE may decode or demodulate the NB PDCCH under the assumption that the UE has received the NB PDCCH to which REG and CCE configuration, interleaving, cyclic shift, and RE mapping are applied on the premise that the NB configured for the UE is the entire system BW.

Meanwhile, a method of configuring such an NB PDCCH transmission duration as a duration starting from a symbol immediately after the WB PDCCH transmission duration may be considered. In this case, the case in which an NB PDCCH transmission symbol does not include a CRS (RE) according the length of the WB PDCCH transmission duration may occur. For example, assuming that a symbol index is started from 0 based on a normal CP, when the WB PDCCH transmission duration consists of two OFDM symbols of OFDM symbol 0 and OFDM symbol 1 and the next NB PDCCH transmission duration consists of two symbols of OFDM symbol 2 and OFDM symbol 3, OFDM symbols for NB PDCCH transmission (hereinafter, NB PDCCH transmission symbols) do not include the CRS (RE) (refer to FIG. 4). In this case, channel estimation performance may be degraded and, therefore, PDCCH reception performance may be deteriorated. Therefore, an embodiment of the present invention proposes that the NB PDCCH be configured/transmitted according to the following methods in consideration of the above disadvantages.

Method 1) Additional RS transmission for NB PDCCH

Method 1 serves to transmit an additional RS (hereinafter, a-RS) only in at least one symbol or one specific symbol (that does not include a CRS) among symbols constituting the NB PDCCH. Specifically, the following cases may be considered in which:

1) when all NB PDCCH transmission symbols do not include the CRS, the a-RS is transmitted/received in one specific symbol (e.g. the first symbol) among the symbols,

2) when a specific NB PDCCH transmission symbol (e.g. the first NB PDCCH transmission symbol) does not include the CRS, the a-RS is transmitted/received in the specific symbol, or

3) the a-RS is transmitted/received in a symbol that does not include the CRS among the NB PDCCH transmission symbols.

Herein, the a-RS may have the same transmission resource (i.e. RE) pattern corresponding to a specific antenna port (e.g. port #0). A sequence for the a-RS:

1) may be configured by a part corresponding to an NB in an entire sequence generated based on a system BW (i.e. a CRS sequence generated according to Equation 3 to Equation 10), or

2) may be generated under the assumption that the corresponding NB is an entire system BW (i.e. N^{DL}_{RB} of Equation 8 is substituted with the number of RBs included in the NB).

Meanwhile, a (fake) multicast-broadcast single-frequency network (MBSFN) subframe may be configured for MBSFN data transmission or relay transmission. In this case, the CRS is not transmitted on OFDM symbols except for a predetermined number of front OFDM symbols in the MBSFN subframe. Accordingly, even in the MBSFN subframe, the a-RS may be additionally configured/transmitted after a legacy WB PDCCH symbol duration. In this case, even in other symbol durations including the NB PDCCH symbol duration, the a-RS may be configured/transmitted for reception and demodulation of a data channel (e.g. a PDSCH). In this case, the a-RS may have the same transmission resource (i.e. RE) pattern as a CRS corresponding to a specific antenna port (e.g. port #0). Similarly, the sequence for the a-RS transmitted through the MBSFN subframe:

1) may be configured by a part corresponding to an NB region in an entire sequence generated based on a system BW, or

2) may be generated under the assumption that the NB is an entire system BW.

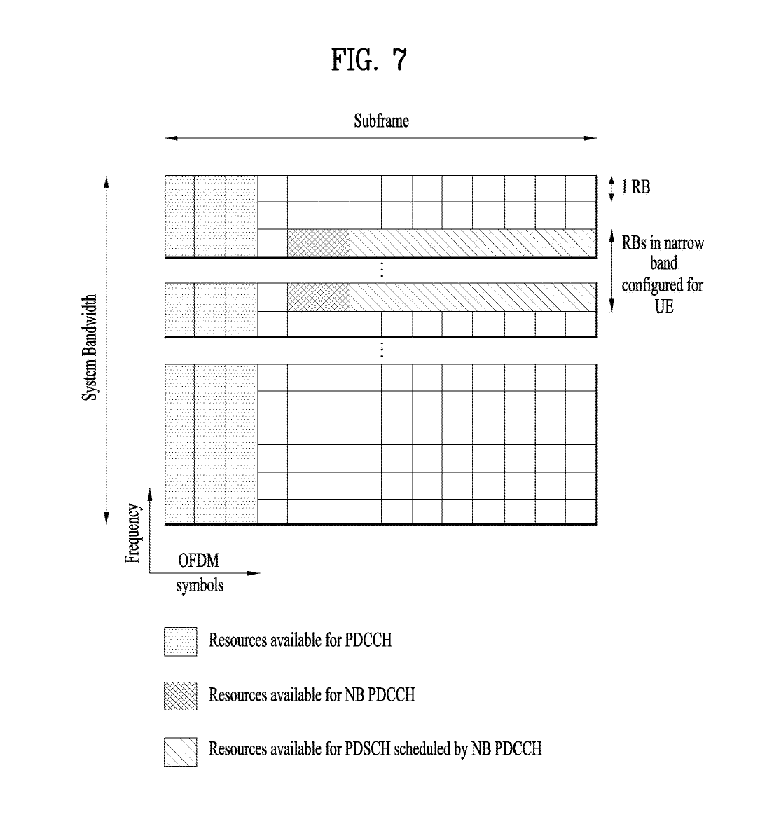

FIG. 7 illustrates exemplary transmission of a DL signal for MTC according to an embodiment of the present invention.

Referring to FIG. 7, a UE may detect an NB PDCCH thereof by monitoring NB PDCCH(s) in an NB that is preset for the UE based on an a-RS. That is, the UE may blind-decode the NB PDCCH in the NB thereof. The UE may receive and/or decode a PDSCH scheduled by the NB PDCCH in the NB based on the NB PDCCH. Although, in FIG. 7, the NB PDCCH and an NB PDSCH are illustrated as if the NB PDCCH and the NB PDSCH are transmitted over an entire NB, RBs in an NB set for the UE represents resources that can be available for transmission/reception of the NB PDCCH/PDSCH and some of the resources may be used to transmit/receive the NB PDCCH/PDSCH. In addition, frequency resources used for transmission/reception of the NB PDCCH and frequency resources used for transmission/reception of the corresponding PDSCH may differ in the NB.

Even when the CRS is not present on OFDM symbol(s) with the NB PDCCH, a channel may be estimated by interpolating a legacy CRS (i.e. a WB CRS) on other OFDM symbols, so that the channel is used to decode the NB PDCCH. Meanwhile, on DL, a band in which an MTC UE operates and on which the MTC UE receives a signal (for inter-band hopping and inter-band measurement), i.e. an NB, may be changed over time. Since the MTC UE does not need to detect/receive a WB PDCCH, the first OFDM symbol may be considered, for efficient resource use, to use the OFDM symbol (on which the first WB CRS is transmitted) in a subframe as a gap for frequency switching/returning. In this case, channel estimation performance based on the WB CRS may be deteriorated due to a gap for band switching. According to an embodiment of the present invention, if the a-RS is added to OFDM symbol(s) with the NB PDCCH, channel estimation (interpolation) performance is improved.

Method 2) Use of symbol with CRS for NB PDCCH

Method 2 serves to configure an NB PDCCH transmission duration so that at least one symbol or one specific symbol among OFDM symbols used for transmission/reception of an NB PDCCH includes a CRS. Specifically, the NB PDCCH transmission duration may be configured such that a specific symbol including the CRS is the first or last symbol among symbols constituting the NB PDCCH. For example, in a situation in which the CRS is transmitted through symbols 0, 4, 7, and 11 among symbols 0 to 13 in a subframe (based on a normal CP), if the NB PDCCH transmission duration consists of two symbols (in a state in which the WB PDCCH transmission duration includes symbol 0 which is the first CRS transmission symbol), the NB PDCCH transmission duration may consist of symbols 4 and 5 or symbols 3 and 4, based on symbol 4, which is the second CRS transmission symbol.

FIG. 8 illustrates exemplary transmission of a DL signal for MTC according to another embodiment of the present invention.

In Method 1 and Method 2, PDSCH transmission scheduled through the NB may be started from a symbol immediately after the NB PDCCH as illustrated in FIG. 7, whereas PDSCH transmission may be started from a symbol prior to the NB PDCCH duration as illustrated in FIG. 8.

From this viewpoint, a method of signaling (corresponding) PDSCH start symbol information (e.g. symbol index) through an NB PDCCH (e.g. DL grant) may be considered.

Alternatively, a CFI value corresponding to an NB PDCCH transmission symbol duration may be semi-statically configured/applied as a fixed value. The PDSCH start symbol information may be indicated by an NB PCFICH used to indicate the PDSCH start symbol information (rather than the CFI value) or by an MTC-dedicated common control channel or signal (having a structure similar to the PCFICH).

Meanwhile, when an NB frequency resource region overlaps the PSS/SSS signal transmission region described with reference to FIG. 3,

1) an NB PDCCH transmission symbol/resource (e.g. RE) except for a corresponding PSS/SSS transmission symbol/resource (e.g. RE) may be configured in a PSS/SSS transmission subframe, or

2) an NB PDCCH may not be configured/transmitted in the PSS/SSS transmission subframe.

In addition, similarly to the case in which the NB region overlaps a PSS/SSS, when the NB region overlaps a PBCH transmission region,

1) an NB PDCCH transmission symbol/resource (e.g. RE) except for a corresponding PBCH transmission symbol/resource (e.g. RE) may be configured in a PBCH transmission subframe, or

2) an NB PDCCH may not be configured/transmitted in the PBCH transmission subframe.

For example, when 6 center RBs are configured as an NB for the UE, the NB PDCCH may be mapped only to OFDM symbols or REs without the PSS/SSS/PBCH among OFDM symbols in the PSS/SSS or PBCH subframe or no NB PDCCH may be configured in the corresponding subframe. When considering MTC having many cases in which instantaneous signal transmission/reception is not needed, no other problems may occur even when transmission of the NB PDCCH is omitted in the PSS/SSS/PBCH subframe.

In addition, in a TDD situation, even when a DwPTS duration for a specific subframe consists of a specific number or less of symbols, the NB PDCCH may not be configured/transmitted. Alternatively, the NB PDCCH in a TDD special subframe may be configured/transmitted only by the remaining number of symbols (herein, Nr) except for legacy WB PDCCH transmission symbols in the DwPTS duration. If a CFI value corresponding to an NB PDCCH transmission duration is semi-statically configured as a fixed value (hereinafter, Nc), an actual number of NB PDCCH transmission symbols in the special subframe may be determined/applied as a minimum value of Nr and Nc.

(2) PCFICH and PHICH signaling for narrowband MTC

A transmission resource of an NB PCFICH may be configured by applying RE/REG mapping in a state in which a corresponding NB is assumed to be an entire system BW. A set of CFI values (i.e. the number of symbols used for a PDCCH) signaled from this NB PCFICH:

1) may be configured identically to a set of CFI values defined in a system BW,

2) may be configured as a set of CFI values (e.g. {2, 3, 4}) defined in the same BW as that of the corresponding NB, or

3) may be configured as a set of CFI values (e.g. {1, 2, 3, 4}) consisting of a total of 4 values including additional transmission of a reserved CFI codeword (e.g. consisting of bit ‘0’ in Table 3).

As another method, in MTC, the NB PCFICH may not be configured/transmitted. Therefore, a CFI value indicating an NB PDCCH transmission symbol duration may be semi-statically configured/signaled through a specific broadcast signal (e.g. an SIB, a random access response (RAR), or a message 4 (Msg4)) or a UE-specific RRC signal. In addition, such a CFI value may be independently configured with respect to each NB (when a plurality of NBs is configured in a system BW for MTC).

In addition. a CFI value for MTC that is signaled through NB PCFICH transmission or a specific broadcast/RRC signal may not be limited to a specific value (e.g. 2) or less even for TDD subframe(s) ⅙ and/or an MBSFN subframe (as opposed to the case of a legacy system and a legacy UE). One of CFI values that can be applied to a normal subframe may be signaled/configured (without additional restriction) even with respect to a specific subframe.

Meanwhile, similarly to the transmission resource of the NB PCFICH, a transmission resource of an NB PHICH may be configured by applying RE/REG mapping in a state in which a corresponding NB is assumed to be an entire system BW. Accordingly, a UE may calculate the number of entire NB PHICH groups in a state in which the NB is assumed to be the entire system BW.

In addition, a PHICH-configuration (PHICH-Config) parameter (e.g. (normal or extended) phich-duration and/or phich-resource (⅙, ½, 1, or 2) etc.) for configuring an NB PHICH resource:

1) may be identically configured to a value signaled from a PBCH, or

2) may be separately signaled through a specific broadcast signal (e.g. an SIB, a RAR, or Msg4) or a UE-specific RRC signal. In addition, such an NB PHICH-Config parameter may be independently configured similarly to the above-described case (when a plurality of NBs is configured in a system BW for MTC).

Meanwhile, information (e.g. a symbol index) about a start symbol of an NB PDCCH and/or a start symbols of a PDSCH scheduled/transmitted through an NB may also be signaled through a specific broadcast signal (e.g. an SIB, a RAR, or Msg4) or a UE-specific RRC signal and the corresponding information may also be independently configured in a similar manner to the above-described case (when a plurality of NBs is configured in a system BW for MTC).

For reference, since the NB PDCCH is transmitted on OFDM symbol(s) except for OFDM symbols that have been used as a legacy control region among subframes in the time domain and is transmitted/received in a partial band instead of being distributively transmitted in an entire system band in the frequency domain, the NB PDCCH may be wrongly recognized similarly to an EPDCCH. However, the EPDCCH is transmitted on symbols from a start OFDM symbol for the EPDCCH to the last OFDM symbol of a subframe among remaining OFDM symbols except for a legacy control region in a subframe as described above. Accordingly, since the UE can decode the EPDCCH only after receiving a signal up to the last OFDM symbol of a subframe and decode again a PDSCH based on the decoded EPDCCH, it is not proper to implement a low-cost/low-specification UE. In contrast, since the NB PDCCH according to the present invention is transmitted/received only on partial OFDM symbols that are located at the front part of OFDM symbols rather than OFDM symbols used as a legacy control region, the UE may decode the NB PDCCH without waiting until the last OFDM symbol of a subframe.

The above-described embodiments of the present invention may be used for communication of various forms/purposes performed between a plurality of normal UEs and an eNB as well as between an MTC UE and an eNB.

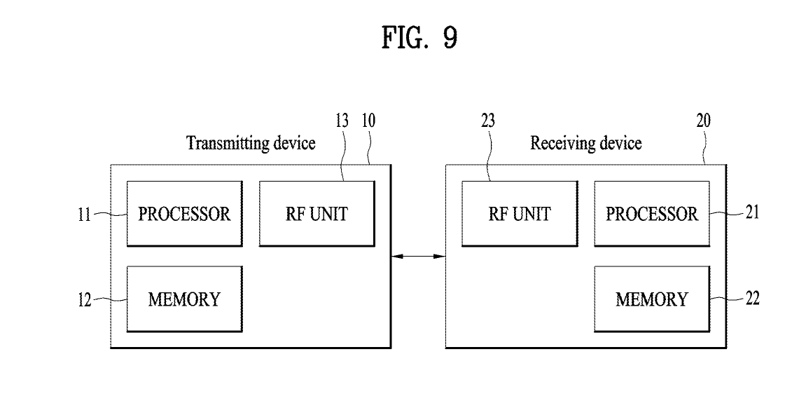

FIG. 9 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11. and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

The eNB processor may control the eNB RF unit to transmit an NB PDCCH and a PDSCH according to scheduling information carried by the NB PDCCH, in an NB preconfigured for the UE in a subframe. The eNB processor may control the eNB RF unit to transmit a PCFICH and a PHICH in the NB according to an embodiment of the present invention. The eNB processor may control the eNB RF unit to transmit an a-RS on at least one of OFDM symbol(s) with the NB PDCCH when the NB PDCCH is transmitted on OFDM symbol(s) without a CRS according to Method 1 of the present invention. Alternatively, the eNB processor may configure an NB PDCCH duration to include at least one OFDM symbol with the CRS according to Method 2 of the present invention. The eNB processor may control the eNB RF unit to transmit information indicating the number and/or location of OFDM symbol(s) available for transmission of the NB PDCCH. The eNB processor may control the eNB RF unit to transmit information indicating a start OFDM symbol with an NB PDSCH.

The UE processor may monitor NB PDCCHs to detect an NB PDCCH in an NB preconfigured for the UE. The UE processor may control the UE RF unit to receive the a-RS or the CRS in an NB in a symbol duration configured for transmission of the NB PDCCH and decode the NB PDCCH based on channel information obtained through the a-RS or the CRS. The UE processor may control the UE RF unit to receive the PDSCH in the NB based on resource allocation information in the NB PDCCH and decode the received PDSCH. The UE processor may control the UE RF unit to receive information indicating the number and/or location of OFDM symbol(s) available for transmission of the NB PDCCH. The UE processor may control the UE RF unit to transmit information indicating the start OFDM symbol with an NB PDSCH. The UE processor may identify a detection location of the NB PDCCH and/or a location at which reception of the PDSCH is to be started, based on such information.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, a UE, or other devices in a wireless communication system.

1. A method of receiving a downlink signal by a user equipment (UE), the method comprising:
receiving a reference signal and a downlink control channel based on the reference signal in a specific band preconfigured for the UE out of an entire system band of a subframe; and
receiving a downlink data channel in the specific band of the subframe based on the downlink control channel,
wherein the specific band is smaller than the entire system band,
wherein the downlink control channel is received in one or more orthogonal frequency division multiplexing (OFDM) symbols except for a predetermined number of front OFDM symbols among OFDM symbols in the subframe,
wherein the downlink data channel is received in remaining OFDM symbols, except the predetermined number of front symbols and the one or more OFDM symbols, and
wherein the reference signal is received in at least one of the one or more OFDM symbols.

2. The method according to claim 1,
wherein the reference signal is at least a cell-specific reference signal defined for antenna port 0, a cell-specific reference signal defined for antenna port 1, a cell-specific reference signal defined for antenna port 2, or a cell-specific reference signal defined for antenna port 3.

3. The method according to claim 1,
wherein, if all of the one or more OFDM symbols on which the downlink control channel is received do not include a cell-specific reference signal, at least one of the one or more OFDM symbols includes an additional reference signal rather than the cell-specific reference signal.

4. The method according to claim 1, further comprising:
receiving information indicating the one or more OFDM symbols on which the downlink control channel is received.

5. The method according to claim 1, further comprising:
receiving information indicating a start OFDM symbol on which the downlink data channel is received.

6. A user equipment (UE) for receiving a downlink signal, the UE comprising,
a receiver, and
a processor, configured to control the receiver, that:
controls the receiver to receive a reference signal and a downlink control channel based on the reference signal in a specific band preconfigured for the UE out of an entire system band of a subframe; and
controls the receiver to receive a downlink data channel in the specific band of the subframe based on the downlink control channel,
wherein the specific band is smaller than the entire system band,
wherein the downlink control channel is received in one or more orthogonal frequency division multiplexing (OFDM) symbols, except for a predetermined number of front OFDM symbols among OFDM symbols in the subframe,
wherein the downlink data channel is received in remaining OFDM symbols except the predetermined number of front symbols and the one or more OFDM symbols, and
wherein the reference signal is received in at least one of the one or more OFDM symbols.

7. The UE according to claim 6,
wherein the reference signal is at least a cell-specific reference signal defined for antenna port 0, a cell-specific reference signal defined for antenna port 1, a cell-specific reference signal defined for antenna port 2, or a cell-specific reference signal defined for antenna port 3.

8. The UE according to claim 6,
wherein, if all of the one or more OFDM symbols on which the downlink control channel is received do not include a cell-specific reference signal, at least one of the one or more OFDM symbols includes an additional reference signal rather than the cell-specific reference signal.

9. The UE according to claim 6,
wherein the processor controls the receiver to receive information indicating the one or more OFDM symbols on which the downlink control channel is received.

10. The UE according to claim 6,
wherein the processor controls the receiver to receiver information indicating a start OFDM symbol on which the downlink data channel is received.

11. A method of transmitting a downlink signal by a base station (BS), the method comprising:
transmitting a reference signal and a downlink control channel based on the reference signal in a specific band preconfigured for a user equipment (UE) out of an entire system band of a subframe to the UE; and
transmitting a downlink data channel based on the downlink control channel to the UE in the specific band of the subframe,
wherein the specific band is smaller than the entire system band,
wherein the downlink control channel is transmitted in one or more orthogonal frequency division multiplexing (OFDM) symbols except for a predetermined number of front OFDM symbols among OFDM symbols in the subframe,
wherein the downlink data channel is transmitted in remaining OFDM symbols, except the predetermined number of front symbols and the one or more OFDM symbols, and
wherein the reference signal is transmitted in at least one of the one or more OFDM symbols.

12. A base station (BS) for transmitting a downlink signal, the BS comprising,
a transmitter, and
a processor, configured to control the transmitter, that:
controls the receiver to transmit a reference signal and a downlink control channel based on the reference signal in a specific band preconfigured for a user equipment (UE) out of an entire system band of a subframe to the UE; and
controls the receiver to transmit a downlink data channel based on the downlink control channel to the UE in the specific band of the subframe,
wherein the specific band is smaller than the entire system band,
wherein the downlink control channel is transmitted in one or more orthogonal frequency division multiplexing (OFDM) symbols except for a predetermined number of front OFDM symbols among OFDM symbols in the subframe,
wherein the downlink data channel is transmitted in remaining OFDM symbols, except the predetermined number of front symbols and the one or more OFDM symbols, and
wherein the reference signal is transmitted in at least one of the one or more OFDM symbols.
